(19) United States
(12) Patent Application Publication
(10) Pub. No.: US 2003/0222386 A1
(43) Pub. Date: Dec. 4, 2003

(54) Combined spring seat isolator and mass damper

(76) Inventors: Markus Duerre, Ann Arbor, MI (US); Bjoern Oppermann, Ann Arbor, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/306,680

(22) Filed: Nov. 27, 2002

Related U.S. Application Data
(60) Provisional application No. 60/333,655, filed on Nov. 27, 2001.

(51) Int. Cl. F16F 1/06

(52) U.S. Cl. 267/166

(57) ABSTRACT

A spring seat isolator/damper is employed with a coil spring having flexible modes corresponding to frequencies of loading causing significantly higher dynamic stiffness amplitudes for the spring. The spring seat isolator/damper has an elastomeric member with a spring seat isolator portion and a mass damper portion, and with the spring seat isolator portion adapted to mount to and receive loads from a vehicle suspension. A damper mass operatively engages the mass damper portion of the elastomeric member such that the damper mass and the damper portion of the elastomeric member have a natural frequency that is substantially equal to at least one of the plurality of flexible modes of the coil spring. This damper, then, will substantially reduce the dynamic stiffness of the spring for that flexible mode.

### CROSS REFERENCE TO RELATED APPLICATIONS

This clams the benefit of United States provisional patent application identified as Application No. 60/333,655, filed Nov. 27, 2001.

### BACKGROUND OF INVENTION

This invention relates in general to spring seats, and more particularly to spring seats in vehicle suspensions combined with tuned mass dampers.

Spring seats are generally provided at the top and bottom ends of a coil spring, such as one provided in the suspension of a vehicle. This coil spring will have a dynamic stiffness that varies with the frequency of the input load. At certain frequencies, the dynamic stiffness will have peak values substantially above the nominal level of stiffness for the spring, called flexible modes of the coil spring. The spring stiffness for these flexible modes may have a spring rate (Newton/millimeter) that is several orders of magnitude greater that the nominal static spring stiffness. In other words, when the spring has a flexible mode in a certain direction, it will be very stiff in that direction at that certain frequency. Since the spring is very stiff at a flexible mode in that direction, it will provide significantly reduced isolation characteristics. For a coil spring in a vehicle suspension, for example, this reduced isolation means that road vibration excitation will be transferred through to the strut, and hence body/frame, almost as if passing through a solid body with high stiffness. Since one of the purposes of the coil spring in a suspension is to isolate the vehicle body from road vibration excitation, the dynamic stiffness at these flexible modes is undesirable. For example, at these flexible mode frequencies, unwanted noise and vibration can pass through the vehicle body to the passenger compartment.

The spring seats to which the coil spring mounts are made of an elastomeric material, such as rubber or microcellular urethane (MCU), creating a spring seat isolator, which will improve the isolation characteristics of the spring/seat assembly somewhat. However, these spring seat isolators essentially improve the isolation somewhat over the entire frequency range, without targeting one or more specific flexible modes of the spring that are of concern. Moreover, they are limited in the ability to even attempt to tune the spring seat because the material cannot be made too soft as that could adversely affect the vehicle ride and handling. Additionally, to have an optimum of effectiveness at reducing the dynamic spring stiffness amplitudes at the flexible modes, any type of damper must be tuned within a relatively tight tolerance with the correct amount of damping power.

Thus, it is desirable to provide spring seat isolators in a coil spring assembly that will significantly reduce at least one amplitude of the flexible mode for the spring mounted in the seats, while still allowing for adequate material properties needed to assure appropriate ride and handling characteristics for a vehicle.

### SUMMARY OF INVENTION

In its embodiments, the present invention contemplates a spring seat isolator/damper adapted for use with a coil spring having a plurality of flexible modes The spring seat isolator/damper includes an elastomeric member having a spring seat isolator portion and a mass damper portion, with the spring seat isolator portion adapted to mount to and receive loads from a vehicle suspension. The spring seat isolator/damper also has a damper mass operatively engaging the mass damper portion of the elastomeric member such that the damper mass and the damper portion of the elastomeric member have a natural frequency that is substantially equal to at least one of the plurality of flexible modes of the coil spring.

The present invention further contemplates a spring/seat assembly. The spring/seat assembly includes a coil spring having a first end and a second end, and having a plurality of flexible modes. A first spring seat isolator is mounted to the first end of the spring, and includes a first elastomeric member having a first spring seat isolator portion and a first mass damper portion, with the first spring seat isolator portion adapted to mount to and receive loads from a vehicle suspension; and a first damper mass operatively engaging the first mass damper portion of the first elastomeric member such that the first damper mass and the first damper portion of the first elastomeric member have a natural frequency that is substantially equal to at least one of the plurality of flexible modes of the coil spring. The spring/seat assembly also includes a second spring seat isolator mounted to the second end of the spring, and including a second elastomeric member having a second spring seat isolator portion adapted to mount to and receive loads from the vehicle suspension.

An embodiment of the present invention also contemplates a method for reducing an amplitude of a dynamic stiffness for at least one flexible mode of a coil spring having a first end and a second end, the method comprising the steps of: providing a first spring seat isolator mounted to the first end of the spring and having a first elastomeric portion and a first damping mass portion; and tuning the first elastomeric portion and the first damping mass portion to have a natural frequency substantially equal to at least one of the flexible modes of the coil spring.

An advantage of the present invention is that the amplitude of transmitted vibration through a spring/seat assembly can be significantly reduced at one or more flexible modes of the spring.

Another advantage of the present invention is that the reduced amplitude of transmitted vibration will reduce the road noise and vibration transmitted into a passenger compartment of a vehicle.

A further advantage of the present invention is that the amplitude of vibration transmitted through the spring/seat assembly can be accomplished while still allowing for an appropriate stiffness of the elastomeric material for the spring seat in order to assure that that the vehicle ride and handling are as desired.

### BRIEF DESCRIPTION OF DRAWINGS

FIG. 1 is a perspective view of a combined isolator/damper assembly in accordance with an embodiment of the present invention;

FIG. 2 is a perspective, partial cutaway view, similar to FIG. 1, on an enlarged scale, of the combined isolator/damper assembly;

FIG. 3 is a plan view, on an enlarged scale, of the combined isolator/damper assembly of FIG. 1;

FIG. 4 is a section cut, on an enlarged scale, taken along line 4-4 in FIG. 3;

FIG. 5 is a perspective view of a damper mass of the isolator/damper assembly of FIG. 1;

FIG. 6 is a perspective view of an insert of the isolator/damper assembly of FIG. 1;

FIG. 7 is a schematic, elevation view of a spring/seat assembly in accordance with a second embodiment of the present invention;

FIG. 8 is a schematic, elevation view similar to FIG. 7, but illustrating a third embodiment of the present invention;

FIG. 9 is a schematic, elevation view similar to FIG. 7, but illustrating a fourth embodiment of the present invention;

FIG. 10 is a sectional view of a isolator/damper assembly in accordance with a fifth embodiment of the present invention;

FIG. 11 is a sectional view of an isolator/damper assembly similar to FIG. 10, but illustrating a sixth embodiment of the present invention; and

FIG. 12 is a sectional view of an isolator/damper assembly similar to FIG. 10, but illustrating a seventh embodiment of the present invention.

### DETAILED DESCRIPTION

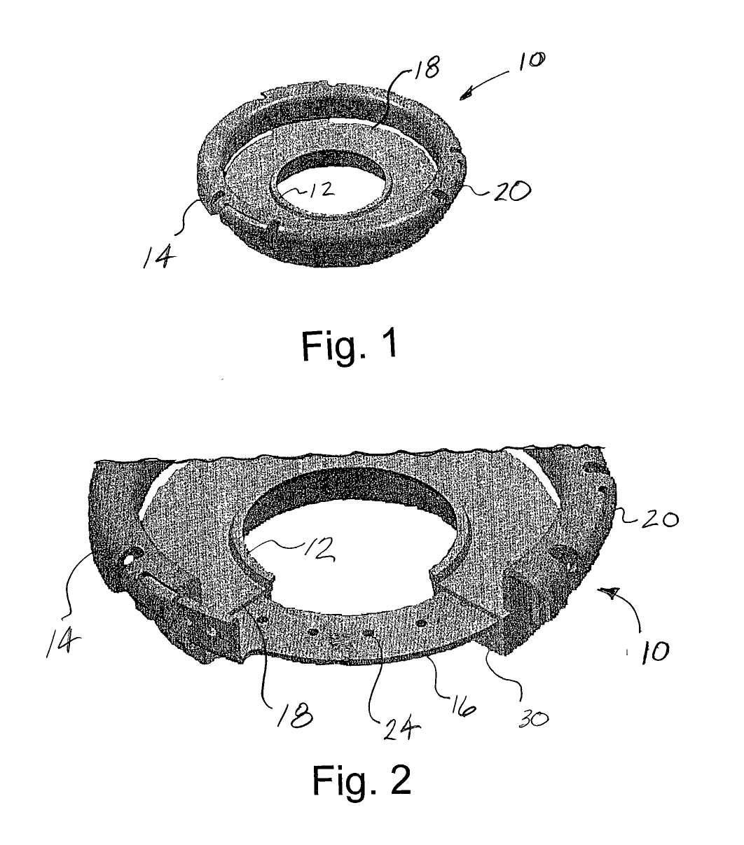

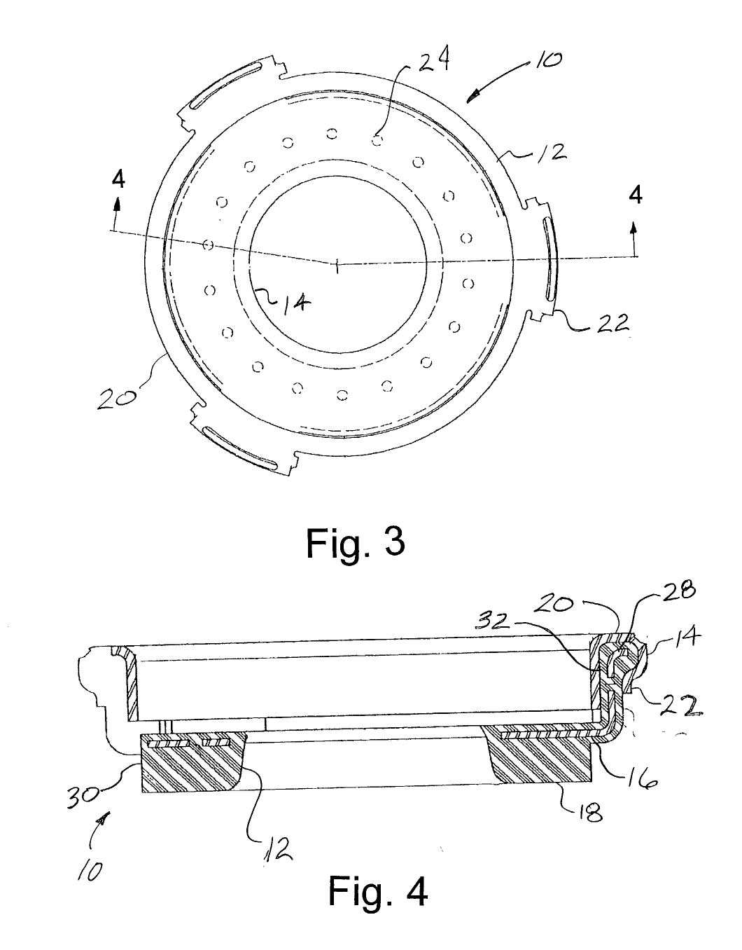

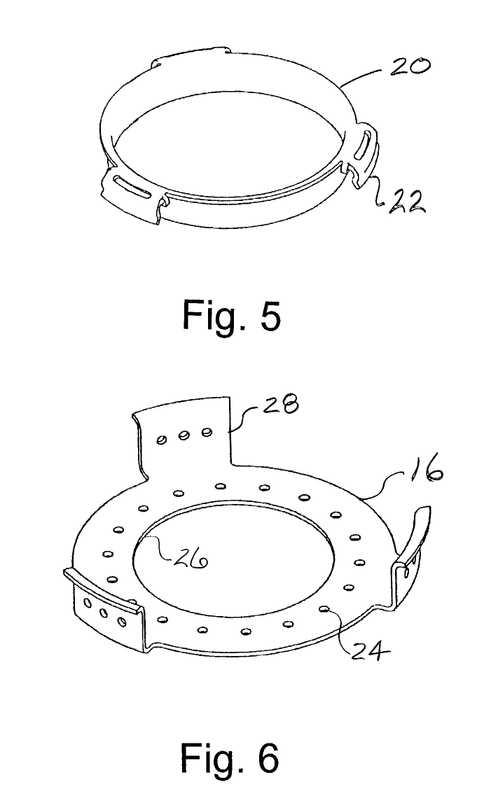

FIGS. 1-6 illustrate a combined isolator/damper assembly 10, which includes a spring seat isolator portion 12 and a linear mass damper portion 14. The assembly 10 includes an insert 16, preferably stamped metal, which is overmolded with an elastomeric member 18. The elastomeric member 18 is preferably formed of either a rubber or a MCU. After overmolding, a damper mass 20 is mounted on the elastomeric member 18 and three ears 22 are formed over the elastomeric member 18 to hold the damper mass 20 in place.

The insert 16 includes a series of holes 24 in a circular portion 26. Extending from the circular portion 26 are three arms 28, each aligning with one of the ears 22 of the damper mass 20. The holes 24 help to better secure the elastomeric member 18 to the insert 16, while the circular portion helps the elastomeric member 18 retain its shape under loading and to redistribute loads. The insert 16 can be relatively small—just sufficient to transmit forces introduced into it. The insert 16 and a seat portion 30 of the elastomeric member 18 surrounding the insert essentially form the spring seat isolator portion 12 of the isolator/damper assembly 10, and function similarly to a conventional spring seat isolator—that is, to transfer loads to and from a spring.

The arms 28, the damper mass 20, and a spring/damper portion 32 of the elastomeric member 18 located between the arms 28 and damper mass 20, essentially form the linear mass damper portion 14 of the isolator/damper assembly 10. The arms 28 transfer the vibrational load from the spring seat isolator portion 12 to the spring/damper portion 32, with the spring/damper portion 32 being a tuned shearing area. The spring/damper portion 32 act as a spring and as a damper in a spring-mass-damper arrangement, while the damper mass 20 acts as the mass portion of a spring-mass-damper arrangement. Consequently, the durometer, shear modulus, shape, thickness, and particular elastomeric material must be chosen to act in concert with the chosen amount of mass for the damper mass 20 and the mass of the insert 16 to reach a resonant frequency at a desired flexible mode of the spring to which the isolator/damper assembly 10 is mounted. That is, the resonant frequency of the linear mass damper portion 14 is tuned to have a resonant frequency that coincides with the flexible mode of the spring for which a reduction in the dynamic stiffness is desired—this will cause the damper to absorb a significant amount of energy out of the system (by converting it to heat) at that frequency, significantly reducing the dynamic stiffness of the overall assembly at that particular flexible mode.

In order to tune the linear mass damper portion 14 to the desired frequency, then, the flexible modes (i.e. the peaks of the dynamic stiffness curve) of the particular spring are needed. While the nominal static stiffness of a coil spring is relatively straight forward, the dynamic stiffness of the particular coil spring can depend upon the particular loads applied to the spring. In the case of a coil spring employed in the suspension of a vehicle, then, it is preferred to determine the flexible modes by compressing the spring to simulate the loading it will receive for the typical weight of the vehicle (and passengers) on which it will be mounted. Then, the spring is excited over various frequencies with, for example, a sinusoidal excitation, while the dynamic stiffness of the spring is measured. The stiffness peaks are the flexible modes. Once the flexible modes are determined, the particular flexible mode for which damping is desired is chosen, and then the linear mass damper portion 14 can be tuned to this particular frequency.

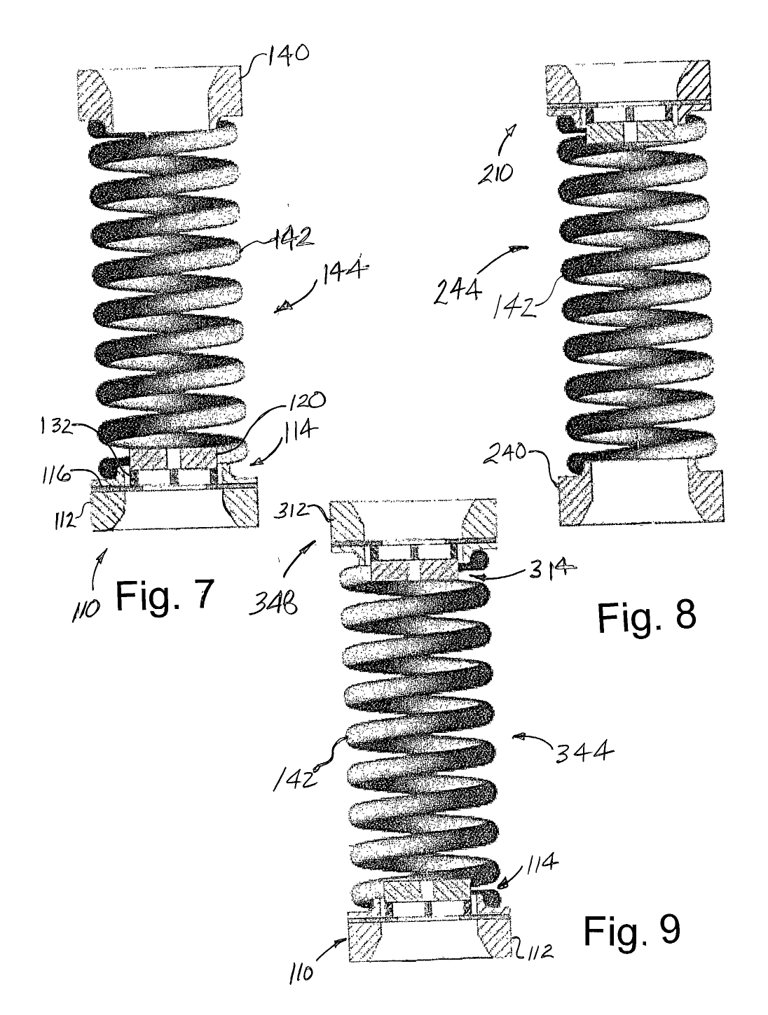

FIG. 7 illustrates a second embodiment of the present invention. For this embodiment, similar elements are similarly designated relative to the first embodiment, but with 100-series numbers. An isolator/damper assembly 110 acts as a lower seat isolator for mounting with an axle side of a vehicle suspension. A generally conventional spring seat isolator 140 acts as an upper seat isolator for mounting with a body side of a vehicle suspension. This spring seat isolator is preferably formed of rubber or MCU, and transfers the spring loading in a conventional fashion known to those skilled in the art. A coil spring 142 is mounted between and supported by the isolator/damper assembly 110 and the spring seat isolator 140 to form a spring/seat assembly 144. The coil spring 142 is generally conventional and preferably formed of metal, as is known to those skilled in the art. The isolator/damper assembly 110 is similar to that disclosed in the first embodiment. It includes a seat spring isolator portion 112 and a linear mass damper portion 114. The linear mass damper portion 114 includes a damper mass 120, coupled to a spring/damper portion 132, with the spring/damper portion 132 secured to a bracket 116.

As in the first embodiment, the mass damper portion 114 is tuned to a resonant frequency that matches a flexible mode in the spring 142 for the particular vehicle with which it is being used. The main difference being that the damper mass 120 and spring/damper portion 132 are generally around an inner radius within the coils of the spring 142, rather than generally around an outer radius outside of the coils of the spring 142.

FIG. 8 illustrates a third embodiment of the present invention. For this embodiment, similar elements are similarly designated relative to the second embodiment, but with 200-series numbers. An isolator/damper assembly 210 acts as an upper seat isolator for mounting with a body side of a vehicle suspension. A generally conventional spring seat isolator 240 acts as a lower seat isolator for mounting with a body side of a vehicle suspension. The coil spring 142 is mounted between and supported by the isolator/damper assembly 210 and the spring seat isolator 240 to form a spring/seat assembly 244. Other than locating the isolator/damper assembly 210 on top of the coil spring 142, this spring/seat assembly 244 is the same as and operates in the same way as the spring/seat assembly of the second embodiment.

FIG. 9 illustrates a fourth embodiment of the present invention. For this embodiment, similar elements are similarly designated relative to the second embodiment, but with 300-series numbers. The spring 142 is again mounted on top of the isolator/damper assembly 110 (forming the lower seat isolator), but the assembly forming the upper seat isolator assembly is also an isolator/damper assembly 348. The second isolator/damper assembly 348 is configured essentially the same as the isolator/damper assembly 210 of FIG. 8, with a spring seat isolator portion 312 and a linear mass damper portion 314. This spring/seat assembly 344 now includes two isolator/dampers 110, 348. For this embodiment, then, the resonant frequencies of the damper portions 114, 314 can be tuned to the same frequency in order to act in concert to reduce the spring stiffness at a particular flexible mode. Or, if so desired, each damper portion 114, 314 can be tuned to a different resonant frequency associated with a different flexible mode in order to decrease the dynamic stiffness of the spring for two different flexible modes. The same type of arrangement can also be applied to the other embodiments disclosed herein in that there can be isolator/damper assemblies mounted at each end of the coil spring—or only at one end, with a conventional spring seat isolator at the other end.

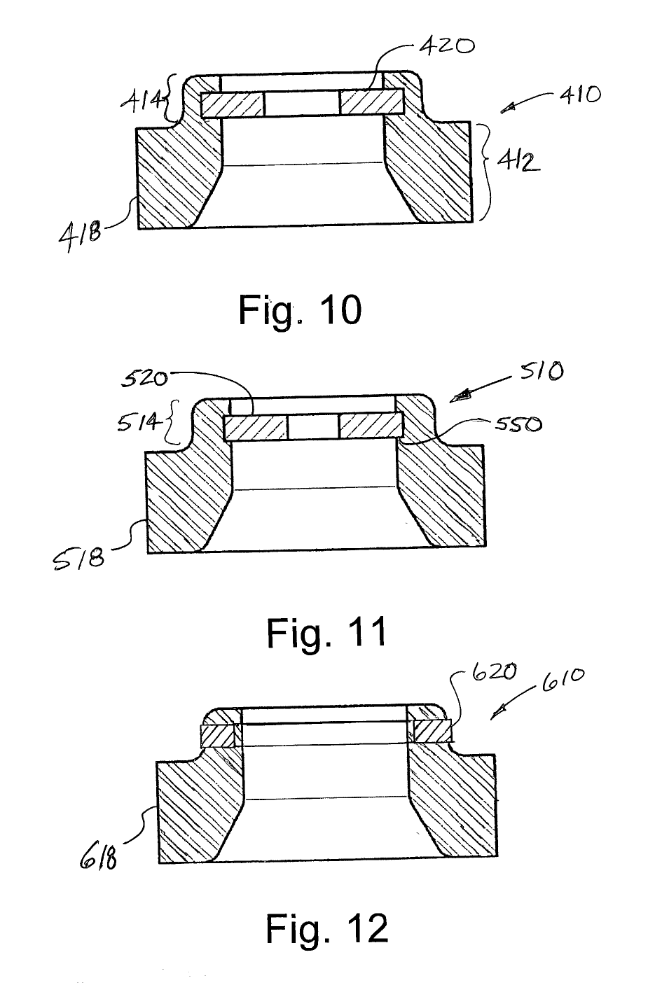

FIG. 10 illustrates a fifth embodiment of the present invention. For this embodiment, similar elements are similarly designated relative to the first embodiment, but with 400-series numbers. An isolator/damper assembly 410 is illustrated where the damper mass 420 is molded into the elastomeric member 418. Again, there is a spring seat isolator portion, indicated generally at 412, which serves the conventional purpose of a spring seat, and a linear mass damper portion, indicated generally at 414, which is tuned to a desired resonant frequency that corresponds to a spring flexible mode. Since this is all molded as one piece, the ability to vary the durometer and shear modulus of the elastomeric material is limited. Consequently, the tuning of the mass damper portion 414 can be accomplished by varying the geometry of the elastomeric material around the damper mass 420, as well as the size of the damper mass 420 (i.e., changing the amount of mass and its contact area with the elastomeric material). This embodiment has the advantage over the previous embodiments in that there are fewer parts and a simpler construction, but the amount of amplitude reduction for the dynamic stiffness at the flexible mode being addressed is probably less with this type of configuration.

FIG. 11 illustrates a sixth embodiment of the present invention. For this embodiment, similar elements are similarly designated-relative to the fifth embodiment, but with 500-series numbers The isolator/damper assembly 510 is essentially the same as in the fifth embodiment except that the damper mass 520 has a smaller radius, thus reducing the contact area 550 with the elastomeric member 518. The reduced contact area lowers the resonant frequency for the mass damper portion 514.

FIG. 12 illustrates a seventh embodiment of the present invention. For this embodiment, similar elements are similarly designated relative to the fifth embodiment, but with 600-series numbers. The isolator/damper assembly 610 again has a damper mass 620 integrally molded into the elastomeric member 618, but it is located adjacent an exterior surface rather than an interior surface. This configuration may be required due to packaging reasons. Otherwise, the assembly 610 operates the same as in the fifth embodiment.

While certain embodiments of the present invention have been described in detail, those familiar with the art to which this invention relates will recognize various alternative designs and embodiments for practicing the invention as defined by the following claims.

What is claimed is:

1. A spring seat isolator/damper adapted for use with a coil spring having a plurality of flexible modes, the spring seat isolator/damper comprising:
an elastomeric member having a spring seat isolator portion and a mass damper portion, with the spring seat isolator portion adapted to mount to and receive loads from a vehicle suspension; and
a damper mass operatively engaging the mass damper portion of the elastomeric member such that the damper mass and the damper portion of the elastomeric member have a natural frequency that is substantially equal to at least one of the plurality of flexible modes of the coil spring.

2. The spring seat isolator/damper of claim 1 wherein the damper mass is integrally molded to the elastomeric member.

3. The spring seat isolator/damper of claim 1 further including an insert member molded integrally with the elastomeric member to thereby provide additional stiffness to the elastomeric member.

4. The spring seat isolator/damper of claim 3 wherein the insert member includes a generally circular portion, located in the spring seat isolator portion of the elastomeric member, and at least one arm extending from the circular portion into the mass damper portion of the elastomeric member, and with the damper mass including at least one ear extending adjacent to the arm with a portion of the elastomeric member sandwiched between the arm and the ear.

5. The spring seat isolator/damper of claim 1 wherein the elastomeric member is made of one of a rubber and a microcellular urethane material.

6. The spring seat isolator/damper of claim 1 wherein the coil spring has a top end and a bottom end, and the spring seat isolator/damper is adapted to mount to the bottom end.

7. The spring seat isolator/damper of claim 1 wherein the coil spring has a top end and a bottom end, and the spring seat isolator/damper is adapted to mount to the top end.

8. A spring/seat assembly comprising:
a coil spring having a first end and a second end, and having a plurality of flexible modes;
a first spring seat isolator mounted to the first end of the spring, and including a first elastomeric member having a first spring seat isolator portion and a first mass damper portion, with the first spring seat isolator portion adapted to mount to and receive loads from a vehicle suspension; and a first damper mass operatively engaging the first mass damper portion of the first elastomeric member such that the first damper mass and the first damper portion of the first elastomeric member have a natural frequency that is substantially equal to at least one of the plurality of flexible modes of the coil spring;
a second spring seat isolator mounted to the second end of the spring, and including a second elastomeric member having a second spring seat isolator portion adapted to mount to and receive loads from the vehicle suspension.

9. The spring/seat assembly of claim 8 wherein the second elastomeric member also includes a second spring seat isolator portion, and wherein the spring/seat assembly further includes a second damper mass operatively engaging the second mass damper portion of the second elastomeric member such that the second damper mass and the second damper portion of the second elastomeric member have a natural frequency that is substantially equal to at least one of the plurality of flexible modes of the coil spring.

10. The spring/seat assembly of claim 9 wherein the natural frequency of the first damper mass and the first damper portion of the first elastomeric member is substantially equal to the natural frequency of the second damper mass and the second damper portion of the second elastomeric member.

11. The spring/seat assembly of claim 9 wherein the natural frequency of the fist damper mass and the first damper portion of the first elastomeric member is different than the natural frequency of the second damper mass and the second damper portion of the second elastomeric member.

12. The spring/seat assembly of claim 8 wherein the first damper mass is integrally molded to the first elastomeric member.

13. The spring/seat assembly of claim 8 wherein the first elastomeric member is made of one of a rubber and a microcellular urethane material.

14. The spring/seat assembly of claim 8 wherein the first spring seat isolator further includes an insert member molded integrally with the first elastomeric member to thereby provide additional stiffness to the first elastomeric member.

15. A method for reducing an amplitude of a dynamic stiffness for at least one flexible mode of a coil spring having a first end and a second end, the method comprising the steps of:
providing a first spring seat isolator mounted to the first end of the spring and having a first elastomeric portion and a first damping mass portion; and
tuning the first elastomeric portion and the first damping mass portion to have a natural frequency substantially equal to at least one of the flexible modes of the coil spring.

16. The method of claim 15 further including providing a second spring seat isolator mounted to the second end of the spring and having a second elastomeric portion and a second damping mass portion; and tuning the second elastomeric portion and the second damping mass portion to have a natural frequency substantially equal to at least one of the flexible modes of the coil spring.

17. The method of claim 16 wherein the step of tuning the second elastomeric portion is further defined by the natural frequency of the second damping mass portion and the second elastomeric portion is the same as the natural frequency of the first elastomeric portion and the first damping mass.

18. The method of claim 16 wherein the step of tuning the second elastomeric portion is further defined by the natural frequency of the second damping mass portion and the second elastomeric portion is different than the natural frequency of the first elastomeric portion and the first damping mass.

19. The method of claim 15 further defined by the coil spring being adapted for use in a suspension of a vehicle.

20. The method of claim 15 further defined by the first elastomeric portion being formed of one of a rubber and a microcellular urethane
